(19) United States
(12) Patent Application Publication
(10) Pub. No.: US 2020/0227991 A1
(43) Pub. Date: Jul. 16, 2020

(54) ELECTRICAL MACHINE

(71) Applicant: GREEN FOX E-SOLUTiONS GMBH, Berlin (DE)

(72) Inventor: Olaf BOETTCHER, Karnenz (DE)

(73) Assignee: GREEN FOX E-SOLUTiONS GMBH, Berlin (DE)

(21) Appl. No.: 16/493,918

(22) PCT Filed: Mar. 12, 2018
(86) PCT No.: PCT/EP2018/056092

§ 371 Date: Sep. 13, 2019

(30) Foreign Application Priority Data
Mar. 13, 2017 (DE) 10 2017 204 072.6

(51) Int. Cl. H02K 21/24; H02K 3/28

(52) U.S. Cl. CPC H02K 21/24; H02K 3/28

(57) ABSTRACT

The present invention relates to an electrical machine comprising at least one disc-shaped stator (1) with at least one winding (7) of electrically conductive wire, and at least one rotor (2) that is rotatable relative to the stator (1) and that has a first permanent magnet (31) and at least one second permanent magnet (32), the magnets being arranged such that a north pole (N) of the first permanent magnet (31) and a south pole (S) of the second permanent magnet (32) point towards the stator (1). The winding (7) is arranged on the disc-shaped stator (1) radially around the circumference in a serpentine configuration having alternating radially arranged portions (8) and tangentially arranged portions (9), such that loops (10) of the winding (7) arranged on two opposing surfaces of the disc-shaped stator (1) only partly overlap one another in their radially arranged portions (8), or only partly overlap one another in their tangentially arranged portions (9), and the winding (7) is arranged alternatively on one of the two surfaces (33, 34) of the disc-shaped stator (1), or one winding (7) of the wire is arranged on each of the surfaces (33,34) of the disc-shaped stator (1).

The present invention relates to an electrical machine having a disk-shaped stator and a disk-shaped rotor.

Electrical machines of various designs are already known from the prior art. For example, printed publication DE 10 2015 102 804 A1 discloses a rotating electrical machine of a disk-type rotor and axial flux design, wherein a stator is arranged between two rotor disks, which incorporate permanent magnets. Although machines of this type permit reliable operation, there is still scope for the optimization of their achievable torque.

The object of the present invention is therefore the proposal of an electrical machine which is designed to permit the most efficient operation possible, with optimum torque.

According to the invention, this object is fulfilled by an electrical machine according to claim 1. Advantageous configurations and further developments are described in the dependent claims.

An electrical machine comprises at least one disk-shaped stator having at least one winding of an electrically-conductive wire and at least one rotor which is rotatable relative to the stator. The rotor is provided with a first permanent magnet and at least one second permanent magnet, which are arranged such that a north pole of the first permanent magnet and a south pole of the second permanent magnet point towards the stator. The winding is arranged on the disk-shaped stator radially around the circumference in a serpentine configuration having alternating radially arranged portions and tangentially arranged portions, such that loops of the winding arranged on two opposing surfaces of the disk-shaped stator only at least partly overlap one another in their radially arranged portions, or only partly overlap one another in their tangentially arranged portions. The winding can be arranged alternately on one of the two surfaces of the disk-shaped stator, or one winding of the wire is arranged on each of the surfaces of the disk-shaped stator.

By the term “disk-shaped”, in the context of the present document, it is specifically to be understood that a corresponding component has a length and a width which are substantially greater than its thickness. Typically, both the length and the width of a disk-shaped component are at least double the thickness thereof. Specifically, the term “disk-shaped” applies to a cylindrical component, the radius or diameter of which is at least double its height. By the arrangement of the winding on the stator in a serpentine configuration, in an overhead view, the arrangement thereof on different surfaces, typically a two-sided arrangement, with portions arranged in the radial direction which are partly or sectionally oriented in a mutually parallel manner (and, specifically in an overhead view, can be arranged in mutually overlying alignment), or portions arranged in the tangential direction which, on both sides, are not entirely, but only partly configured in a mutually overlying arrangement, a layout is produced in which, in an overhead view, two lobes of the serpentine configuration which are arranged on mutually opposing surfaces of the disk-shaped stator are consolidated to form a closed loop such that, upon the application of an electric current from a current source or a voltage source, on the grounds of the Lorentz force, a correspondingly oriented magnetic field is constituted, which can interact with the permanent magnets. By means of the arrangement described, the density of these closed loops over the circumference of the stator is increased, such that a correspondingly higher torque can also be generated. The result is thus a brushless electrical machine, typically with no back-iron, which can be operated in an efficient manner. The surfaces to which the winding is applied typically incorporate, in the direction of the rotor, or are, in the case of a cylindrical disk, the cylinder surfaces.

It can be provided that at least one of the lobes on one of the two surfaces of the stator is configured as a multiple turn of the electrically conductive wire. By a multiple wraparound of one of the lobes (thus constituting a loop), the Lorentz force can be correspondingly amplified, and the torque adjusted accordingly.

Typically, the constituent wire of the winding arranged on different surfaces of the disk-shaped stator is arranged with a spatial clearance from the wire on the respective other side. By means of this spatial clearance, it is ensured that no electrical short-circuits occur. The wire is preferably provided, in any event, with an electrically-insulating coating wherein, however, safety is further improved by the arrangement of a stator disk for the setting of a spatial clearance. Specifically, it can be provided that, even in the event of a changeover of the wire from one side to the other, a spatial clearance is maintained.

The rotor can comprise at least two disks, which are arranged coaxially to one another, and between which one disk of the stator is arranged respectively. The rotor and the stator are arranged with a spatial clearance from one another, i.e. each of the disks of the rotor is spaced from an adjoining disk of the stator. This produces a compact, but nevertheless efficient design. Typically, a plurality of disks of the rotor is arranged on a shaft, which is centrally supported in the disk of the stator or in the disks of the stator. The rotor and the stator are thus preferably configured in a coaxial arrangement, wherein one rotor disk respectively can be provided at the start and end of the shaft. The rotor disks are secured to the shaft here, whereas the stator disks can be secured to a base plate or to a housing. However, it can also be provided that the stator disks are secured to the shaft, and the rotor disks are fitted to the base plate and/or to the housing.

The permanent magnets on the rotor should be arranged with a clearance to the midpoint of the rotor disk, wherein the winding is also arranged on the stator, such that there is a correspondence between the permanent magnets and the winding. The rotor disk itself can be comprised of a material which is not ferromagnetic. Typically, the material is a plastic, and the rotor disk is produced by an injection-molding method. The at least two permanent magnets are typically arranged on the rotor disk or are incorporated in the rotor disk. An upper side of one of the permanent magnets can terminate flush to a surface of the rotor disk.

Preferably, the permanent magnets are arranged on at least one circular path on the rotor disk, and are configured with an identical clearance to a mid-point. If more than two permanent magnets are provided, the permanent magnets can also be arranged on two, three or more circular paths.

In order to constitute an electric motor, three rotor disks can be provided, which are arranged coaxially to one another, and between which one disk of the stator is arranged in each case. This permits a multi-phase, preferably a three-phase actuation. Given that, in conventional motors or generators, for the amplification of a magnetic field, a back-iron is provided which, in the present invention, is omitted altogether, the resulting power gain is greater if the additional weight associated with the back-iron is replaced by a stator disk and a rotor disk of lower weight. The rotor preferably comprises at least four disks, which are arranged coaxially to one another, and between which one disk of the stator is arranged in each case, such that an electric generator or motor is constituted. By means of this modular design, a variability of the electrical machine is increased. It can also be provided that the permanent magnets of the rotor are arranged on individual circular or annular modules, wherein individual modules can be combined to constitute a complete rotor disk. This permits the rapid setting of any desired combination of permanent magnets on the rotor, thereby adjusting the capacity of the electrical machine.

Preferably, the permanent magnets are only, i.e. exclusively arranged on the rotor, and the stator is free of permanent magnets. As a result, a magnetic field on the stator can only be constituted by the winding. The rotor and stator are typically arranged with a mutual spatial clearance, such that the rotor can rotate in relation to the stator.

The electrical machine is preferably provided with an electric current source and/or an electric voltage source, to which the electrically-conductive wire can be, or is connected. The electrically-conductive wire is typically connected to the current source or voltage source such that, in the radially arranged and, on different sides, at least partially mutually overlying portions, in at least one of the latter, and typically in all of said portions, an electric current flows in the same direction in each case, such that a correspondingly oriented Lorentz force is constituted.

The electric current source or electric voltage source can be operated in a pulsed manner, such that a pulsed electric current flows in the winding. A control unit can also be provided on the electric motor. This control unit can specifically be designed to control the pulses of electric current, such that the electric current in the winding is minimized when the portions arranged in the radial direction are in alignment over the permanent magnets, whereas the electric current is limited, with respect to its current strength, where the portions arranged in the radial direction do not overlap any of the permanent magnets, considered in an overhead view.

Typically, where three stator disks are provided, the windings of said stator disks are connected to the electric current source or electric voltage source such that a phase angle of an electric current in one of the windings of the three disks of the stator respectively shows a difference of 120° in relation to an electric current which flows in a winding of one of the other disks of the stator. A three-phase operation can thus be permitted accordingly.

The permanent magnets can all be of an identical shape and/or size, but can also at least be configured in differing pairs. Specifically, at least one of the permanent magnets can be of a different shape or size from the remaining permanent magnets.

It can be provided that the electric current source for the supply of the stator windings is supplied with electric current, and the winding on one surface of the stator assumes a phase angle which, in relation to the electric current flowing in the winding arranged on the other surface of the stator, shows a phase angle difference of between 80° and 100°, preferably 90°.

The winding can be arranged such that a point on one winding which is closest to the midpoint of the stator disk, relative to said midpoint, is arranged radially below a point on the winding on the other surface which is midway between the closest point and the furthest removed point thereof. In the context of the present document, a phase angle of 360° can be defined in that a clearance between two or three portions of the winding arranged in a radial direction corresponds to a phase angle of 360°.

Typically, the winding is constituted of at least two individual wires, oriented in a mutually parallel direction on one of the surfaces. An electric current flux can thus be adjusted accordingly, whilst still permitting the achievement of a compact design.

The winding can be constituted of a flat wire. The flat wire is arranged such that one of its broader faces or surfaces is oriented parallel to an axis of rotation of the electrical machine, about which the rotor is rotatably mounted. The broader surface is thus oriented parallel to a direction of the magnetic flux, and orthogonally to the longitudinal axis of the flat wire. A flat wire is specifically to be understood as any wire which, in cross-section, i.e. parallel to its longitudinal axis, assumes a rectangular cross-section wherein, typically, a width thereof exceeds the thickness. Preferably, the width is at least double the thickness. The flat wire can be constituted of aluminum, preferably anodized aluminum, copper or another electrically-conductive alloy or metal. The flat wire is preferably wound free of kinks, such that a winding is constituted with minimal electrical resistance, and the generation of electrical eddy currents is suppressed to the greatest possible extent. It can also be provided that the flat wire (which is typically between 2 mm and 10 mm, and preferably 5 mm in width) is applied in multiple layers to constitute the winding.

Typically, the winding is secured in a recess in the stator. By the incorporation in the stator disk of a recess for the accommodation of the constituent wire of the winding, the wire can also be applied in a multi-layered, and thus compact arrangement. The fixing can comprise a mechanical fixing by way of at least one clamp or one projection, around which the wire is routed. Alternatively or additionally, however, the recess can also be filled with a resin or an adhesive, in order to secure the wire in position.

It can be provided that the winding forms at least four loops wherein, on each side of the stator disk, two lobes are arranged which, in an overhead view, combine to form the four loops.

The serpentine winding can assume a periodic shape, wherein a structure of the winding is repeated at specific spatial intervals. For example, each of the loops in the serpentine configuration is of an identical design, such that a rotationally symmetrical arrangement of the winding on the stator is provided, in other words, a waveform.

A changeover of the winding from one side of the stator to the other is typically achieved by means of a cut-out or a plurality of cut-outs in the stator disk. These cut-outs can be arranged at different distances from the midpoint of the disk-shaped stator. Preferably, at least one cut-out is arranged in a position at which winding assumes a minimum clearance to the midpoint or a maximum clearance to the midpoint. However, the cut-out can also be arranged centrally between the two above-mentioned positions. In a preferred manner, a changeover of sides occurs periodically, typically after each lobe or each loop of the winding.

In a preferred manner, the winding is alternately arranged on one of the two surfaces of the stator, wherein the two surfaces each comprise a winding former, onto which the winding is wound. The winding is typically fed radially at least once through a cut-out in the recess, and wound onto the winding former on the opposing surface.

At least two interlocking windings are arranged on the disk-shaped stator, wherein each of the windings is fed tangentially at least once through a cutout to the opposing surface. This permits an exceptionally space-saving arrangement, with a high density of lobes.

It can be provided that three, preferably exactly three interlocking windings are arranged on the disk-shaped stator. Each of the windings incorporates tangential portions comprising at least one midpoint-proximate portion and at least one midpoint-distant portion, at which the respective winding is fed from the surface of the stator through the cut-out to the opposing surface. A particularly space-saving design is achieved as a result.

Preferably, each of the cut-outs through which one of the windings is fed is arranged between a radial portion of a winding adjoining said winding which is routed on one surface, and a radial portion of a further winding which adjoins said winding and is routed on the opposing surface.

The electrical machine described can be configured in a disk-type rotor design and/or in axial flux design.

The lobes of the winding can be provided in an exactly equal number to the permanent magnets on the rotor. Alternatively, the number of lobes can be a whole-number multiple of the number of permanent magnets, or the number of permanent magnets can be a whole-number multiple of the number of lobes of the winding. Alternatively, the ratio can also be 3:4, or a whole-number multiple thereof. The number of lobes of the winding and the number of permanent magnets are to be considered in pairs for a respective stator disk and an adjoining rotor disk, where a plurality of rotor disks and/or a plurality of stator disks are provided. The rotor disks can each be of an identical design, i.e. can specifically incorporate an identical number of permanent magnets, although it can also be provided that at least one of the rotor disks is of a differing design from the remaining rotor disks, for example having a reduced or increased number of permanent magnets. In a similar manner, all the stator disks can be of an identical design, specifically with respect to the number of lobes, but at least one of the stator disks can be of a differing design from the remaining stator disks.

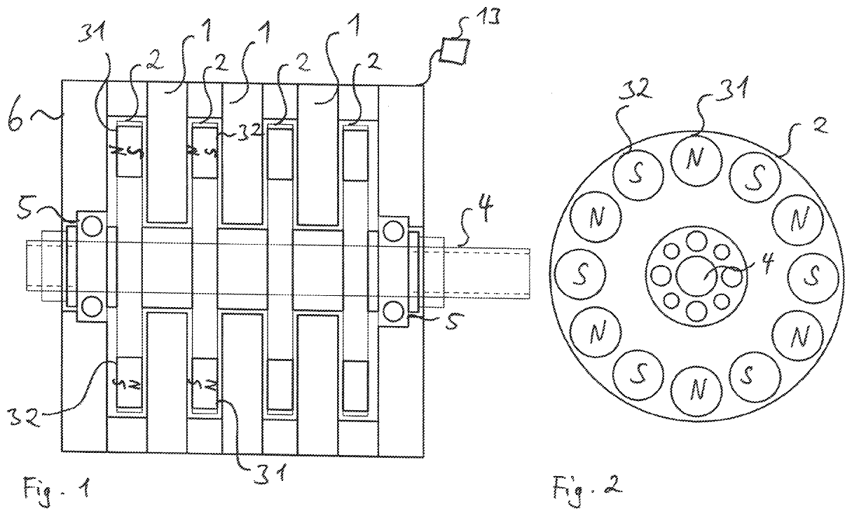

Exemplary embodiments of the invention are represented in the drawings, and are described hereinafter with reference to FIGS. 1 to 19.

In the figures:

FIG. 1 shows a schematic lateral view of an electrical machine;

FIG. 2 shows an overhead view of a rotor;

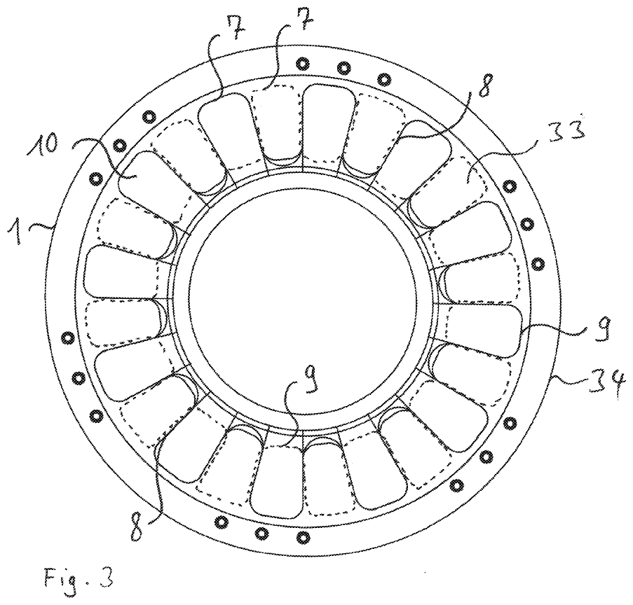

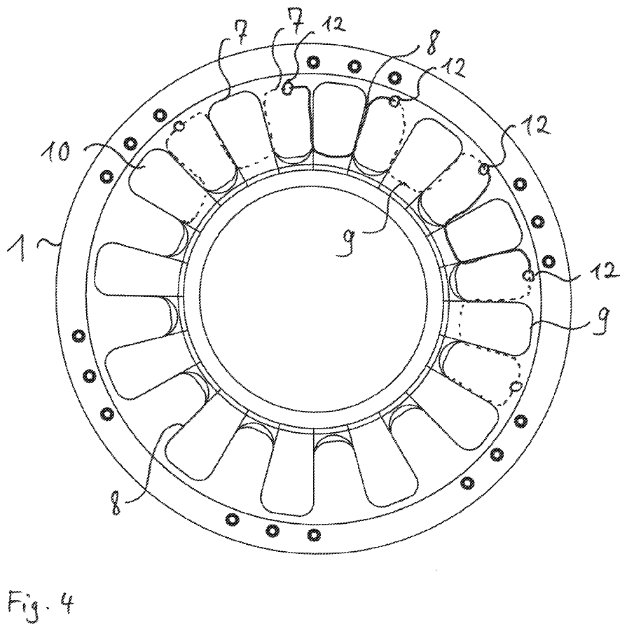

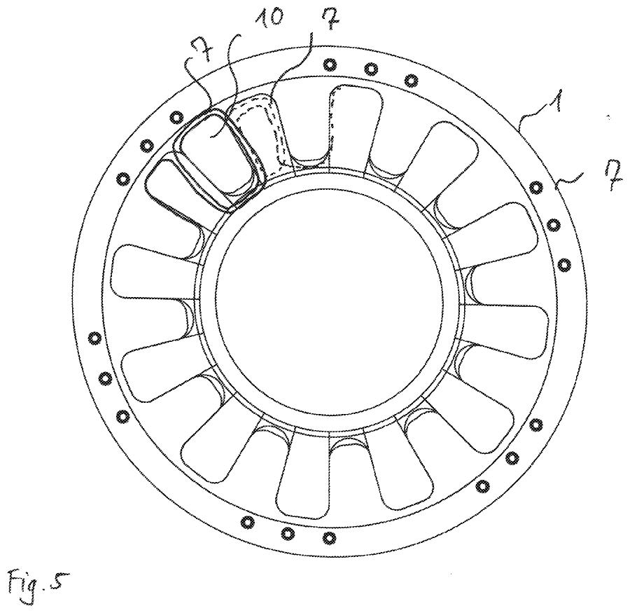

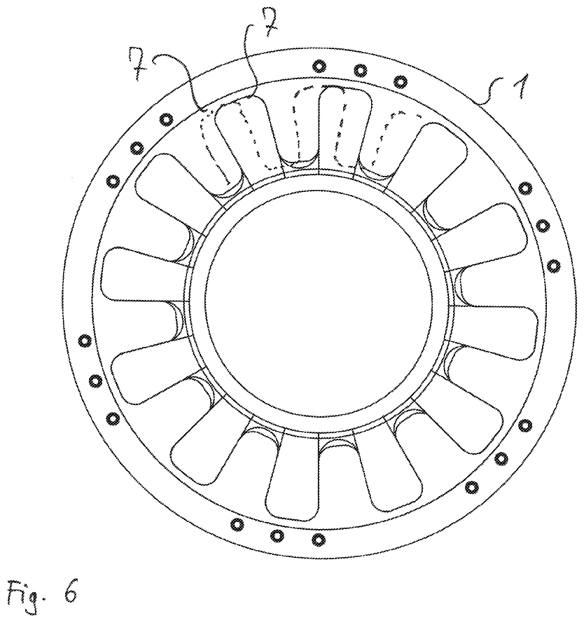

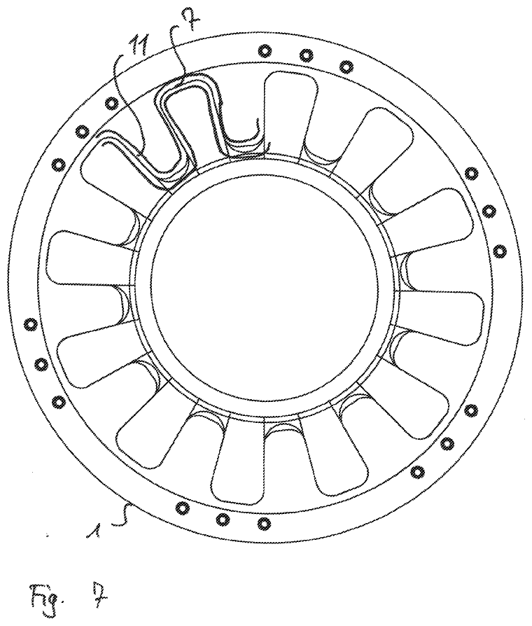

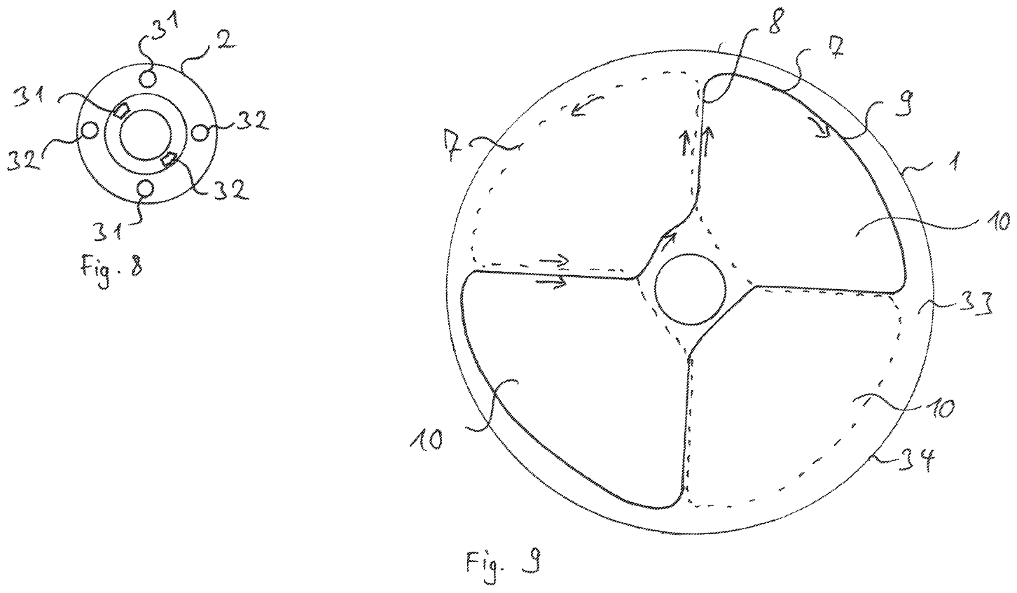

FIG. 3 shows a view of a stator corresponding to FIG. 2;

FIG. 4 shows a view of a stator corresponding to FIG. 3, in which a winding is alternately routed on different sides;

FIG. 5 shows a view of a stator corresponding to FIG. 3, in which a winding is circumferentially arranged a number of times about a lobe of a serpentine configuration;

FIG. 6 shows a view of a stator corresponding to FIG. 3, wherein two windings are arranged with a mutual offset on different sides;

FIG. 7 shows a view of a stator corresponding to FIG. 3, wherein the winding is secured in a recess in a stator disk;

FIG. 8 shows a view of a rotor corresponding to FIG. 2, with differently shaped permanent magnets;

FIG. 9 shows a view of a stator corresponding to FIG. 3, with two windings routed on different sides;

FIG. 10 shows a schematic view of a multiple winding;

FIG. 11 shows a schematic view of a periodic winding;

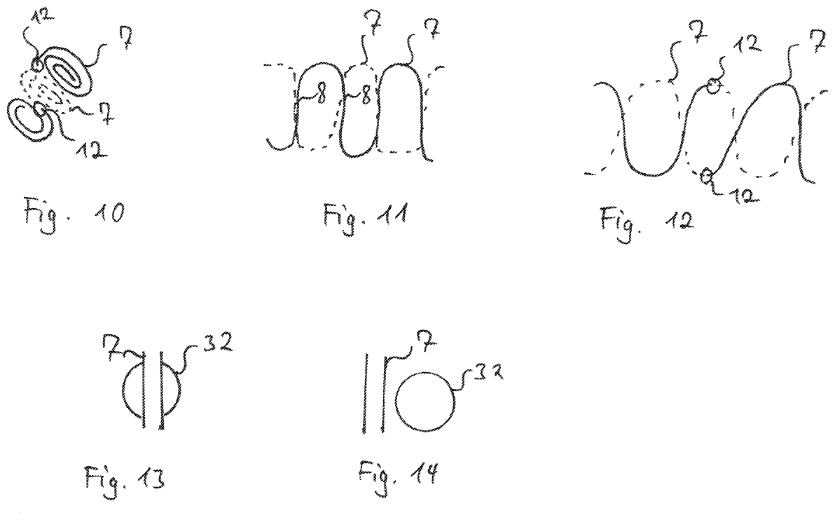

FIG. 12 shows a schematic view of a periodic winding corresponding to FIG. 11, with a changeover of sides;

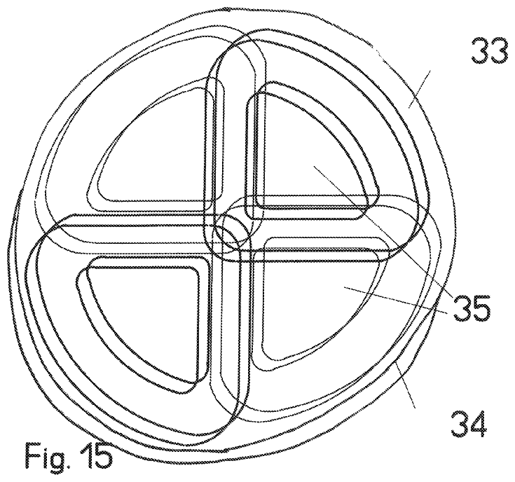

FIG. 13 shows an overhead view of a wire, which is arranged above a permanent magnet;

FIG. 14 shows a view of the wire corresponding to FIG. 13, which is arranged next to the permanent magnet;

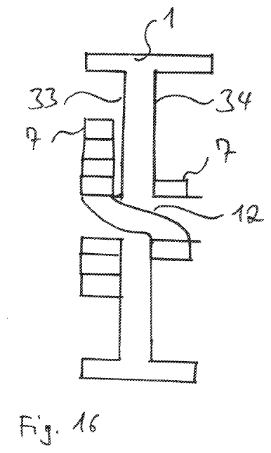

FIG. 15 shows an overhead view of a stator with winding formers;

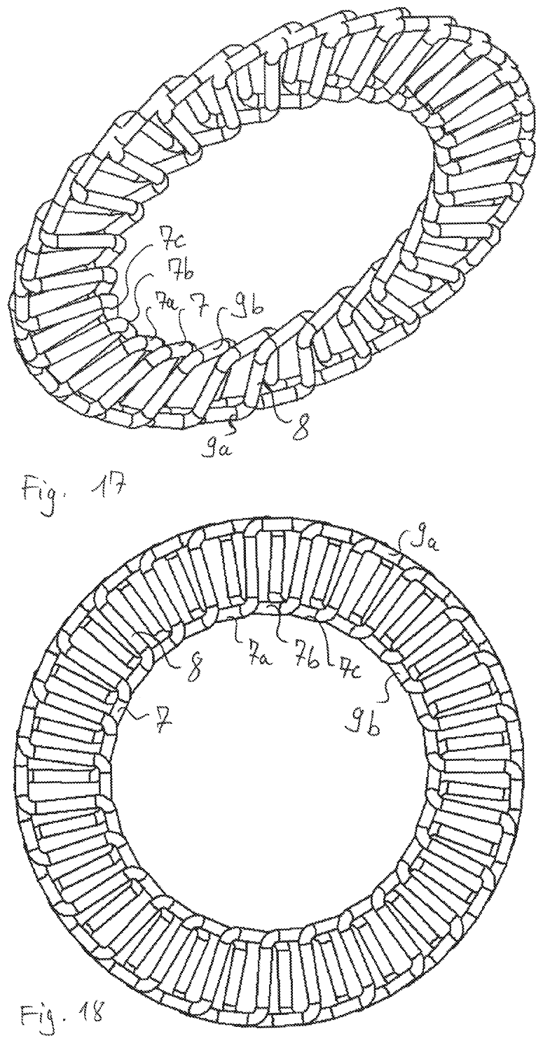

FIG. 16 shows a lateral view of the stator with a flat wire wound thereupon;

FIG. 17 shows a perspective view of a plurality of circular and mutually interlocked wire bundles;

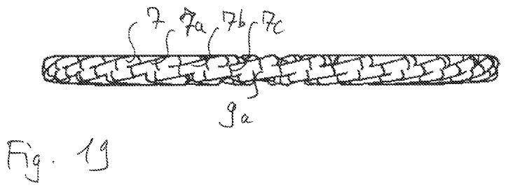

FIG. 18 shows an overhead view of the wire bundles represented in FIG. 17, and

FIG. 19 shows a lateral view of the wire bundles represented in FIGS. 17 and 18.

FIG. 1 shows a schematic view of a brushless electrical machine, with no back-iron, of a disk-type rotor and axial flux design. In a housing 6, which can be constituted of a plastic or a metal, a shaft 4 is supported on ball bearings 5. On the shaft 4, in the exemplary embodiment represented, a total of four disk-shaped rotors 2 are secured in a mutually parallel arrangement. On each of the rotors 2, at least two permanent magnets 31 and 32 are arranged with an alternating orientation, i.e. at least one north pole of one of the permanent magnets 31, 32 and at least one south pole of one of the permanent magnets 31, 32 are oriented in different directions. Between the rotor disks 2, a disk-shaped stator 1 is arranged in each case, which is connected to the housing 6. In each of the stator disks 1, a winding of an electrically-conductive wire is carried which, upon the application of an electric current, as a result of the Lorentz force, engages in a reciprocal action with the permanent magnets 31, 32, such that the rotors 2 are rotated in relation to the stator 1 and the housing 6. The stator disks 1 are also arranged parallel to one another and parallel to the rotor disks 2. In the exemplary embodiment represented, the stator disks 1 and the rotor disks 2 are constituted of a plastic, but can also be constituted of other materials. Preferably, however, materials are employed which have no ferromagnetic properties. In further exemplary embodiments, the stator disks 1 and the rotor disks 2 can also be arranged on the shaft 4 between two disks of Mu-metal.

Although, in the exemplary embodiment represented, four rotors 2 are employed, further exemplary embodiments can provide for any number of rotors 2, from at least one single rotor 2 upwards, and likewise for any number of stators 1. For the constitution of a three-phase electric motor, three rotor disks 2 are configured in a mutually parallel arrangement. By the incorporation of a fourth rotor disk 2, an electric generator can be constituted. The windings of the stator disks 1 are preferably of a mutually identical design and, in an overhead view, are aligned one above another, in the interests of the concentration of the magnetic field generated.

Only a schematic representation of a control unit 13 is shown in FIG. 1, which comprises a current source or a voltage source, by means of which the winding of the stator 1 can be supplied with a pulsed electric current.

FIG. 2 shows one of the rotors 2 in an overhead view. Recurrent characteristics in this figure, and in the subsequent figures, are identified by identical reference symbols. The exemplary embodiment of a rotor disk 2 is cylindrical, i.e. circular in an overhead view and, circumferentially about the shaft 4, on which the rotor 2 is secured, a plurality of permanent magnets 31 and 32 with alternating polarities are arranged with a respectively identical spacing from a midpoint of the rotor disk 2. A pair of adjoining permanent magnets 31, 32 thus respectively comprise a north pole and a south pole, which are oriented in the direction of one of the stator disks 1.

In further forms of embodiment, the permanent magnets 31, 32 can also be arranged with different spacings to the midpoint of the rotor disk 2.

A stator disk 1 with a winding 7 of an electrically-conductive wire is represented in an overhead view in FIG. 3. The stator disk 1 is likewise cylindrical, and is thus circular in an overhead view. On the stator disk 1, circumferentially about the midpoint of the disk, the winding 7 is applied in a serpentine configuration. This serpentine configuration constitutes a plurality of lobes 10, respectively comprised of two portions 8 which are oriented in a radial direction, i.e. in the same direction as a radius running from a midpoint to an edge of the disk, and a portion 9 which is oriented in a tangential direction, i.e. in an orthogonal direction to the radius of the disk, or in the circumferential direction. In the exemplary embodiment represented, in each case, a single wire for the constitution of the winding 7 is arranged on a first surface 33 or side of the stator disk 1, and is thus spatially separated from the winding 7 on a second surface 34, which lies opposite the first surface 33. Here the first surface 33 and the second surface 34 are perpendicular to an axis of rotation of the rotor 2. The winding 7 described by a solid line indicates the winding 7 located on a side which faces the viewer, whereas a broken line identifies the winding 7 on a side which is averted from the viewer.

As shown in FIG. 3, the windings 7 arranged on different sides of the stator disk 1 extend such that, in an overhead view, closed loops are constituted on the lobes 10, on which a respectively differently oriented magnetic field is constituted from loop to loop upon the application of an electric current, such that a reciprocal interaction with the permanent magnets 31, 32 of the rotor 2 is possible. To this end, the windings 7 on the different sides are at least partially arranged in mutually parallel radial portions 8, and are specifically arranged in alignment one above another. A number of loops thus constituted preferably corresponds to a number of permanent magnets 31, 32. In general, all the stator disks 1 of the electrical machine represented in FIG. 1 and all the rotor disks 2 are of a respectively identical design, although at least one of the stator disks 1 and/or one of the rotor disks 2 can also assume a differing configuration from the remaining disks. The stator disk 1 and/or the rotor disk 2 is preferably constituted of a plastic or of another non-ferromagnetic material.

FIG. 4 represents a further form of embodiment of the stator disk 1, wherein the stator disk 1 incorporates cut-outs 12, at which the constituent wire of the winding 7 is fed from one side of the stator disk 1 through to the other side of the stator disk 1. The winding 7 is configured periodically, and the cutouts 12 are also arranged periodically, in each case, in the exemplary embodiment, centrally on a tangential section 9 at a maximum distance from the midpoint of the stator disk 1. FIG. 4 shows a schematic representation, wherein the winding 7 is only partially illustrated, but is naturally further configured circumferentially. In further exemplary embodiments, however, the cut-outs 12 can also be arranged in other positions, for example centrally on a tangential portion 9 which is configured at a minimum distance, or on a radial portion 8.

As shown in FIG. 5, again in a schematic representation, at least one of the windings 7 can execute a multiple wraparound about at least one of the lobes 10 of the serpentine configuration, such that a loop is already constituted on one side of the stator disk 1. In this exemplary embodiment, again, although the winding is fully circumferential 7, it is only partly illustrated, in the interests of clarity. In a preferred manner, all the lobes 10 of the serpentine configuration, wherein the constituent electrical wire of the winding 7 changes sides respectively down-circuit of a lobe 10.

In order to generate a high starting torque, the windings 7 on either side of the stator disk 1 can also be arranged with a mutual offset, as shown in FIG. 6, in an overhead view which corresponds to FIG. 3. Portions 8 of one winding 7 arranged in the radial direction are not executed in an overlying arrangement with the corresponding portions 8 of the other winding 7, although the portions arranged in the tangential direction are at least partially arranged one above another. Accordingly, a phase angle difference of 90° can be achieved between the windings 7 arranged on different surfaces of the stator disk 1 such that, at all times, a torque is generated, and a start-up of the machine is facilitated. Again in FIG. 7, in the interests of clarity, the winding 7 is not shown in a fully circumferential representation.

The constituent wire of the winding 7 is preferably accommodated and secured in a recess 11 in the stator disk 1 in an exclusively mechanical manner, by means of clamps. In further exemplary embodiments, however, the wire can also be adhesively bonded in the recess 11, or can be secured to a stator disk 1 with no recess 11, by clamping or adhesive bonding. However, an accommodation thereof in a recess 11 is specifically appropriate, if the winding 7 is comprised of a plurality of individually and mutually parallel oriented wires. FIG. 7 is a schematic representation wherein, in reality, both the recess and the winding in the exemplary embodiment represented are configured in a fully circumferential arrangement about the stator disk 1.

The wire itself is typically a flat wire of anodized aluminum, the broader sides of which are oriented parallel to the shaft 4. By this arrangement, a winding which is free of kinks can be constituted on the sides of the stator disk 1 as required.

The rotor disk 2 can also be constituted, in a modular manner, from a plurality of individual disks which can be interlocked in a flush-fitted manner, as represented in an overhead view in FIG. 8. The permanent magnets 31 and 32 are not required to assume an identical shape but, in an overhead view, can be circular or rectangular, specifically quadrilateral or arc-shaped. The permanent magnets 31 and 32 are supported in the stator disk 1 such that the surface thereof terminates flush to the surface of the stator disk 1, however, in further exemplary embodiments, they can also project from the stator disk 1.

For the clarification of the operating principle, FIG. 9 shows a rotor disk 2 having one winding 7 respectively on either side. Each of the windings 7 is comprised of only two lobes 10, in which an electric current flows in the directions indicated by the arrows. As a current flux in the radial portions 8 is equi-directional in each of the two windings 7, a torque is constituted in each of the loops, which can interact with the permanent magnets 31, 32, and torque density is increased with a reduced consumption of material, and a corresponding saving in weight.

FIGS. 10 to 12, again in a schematic overhead view, show various configurations of the winding 7. In FIG. 10, each lobe 10 carries a multiple wraparound of the wire which, by the use of the above-mentioned flat wire, can be achieved in a particularly simple manner, before the wire is fed through a cutout 12 to another side of the respective stator disk 1.

In the exemplary embodiment represented in FIG. 11, the windings 7 are serpentine-shaped, and are arranged with a mutual offset of 180° on different sides of the stator disk 1. Even where the wire employed is generally enclosed in an electrically-insulating coating, adjoining portions 8 of the wire, in the radial direction, are spaced from one another, and are thus not in direct physical contact.

Finally, FIG. 12 shows a periodic arrangement of the windings 7 on different sides of the stator disk 1 wherein, at the cut-outs 12, a changeover of the wire from one side to the other is executed in each case.

FIGS. 13 and 14 represent an overhead view of part of the constituent electrically-conductive wire of the winding 7, in various relative positions to one of the permanent magnets 32. Whereas, in FIG. 13, the wire is arranged centrally above the permanent magnet 32, the permanent magnets 31, 32 in FIG. 14 are no longer overlapped by the wire to any degree. The control unit 13 can be set such that, in the situation represented in FIG. 13, in which the current induced in the wire is at a maximum, no electric current flux is permitted in the wire whereas, upon the further movement of the wire towards the position represented in FIG. 14, the current flux increases until, in the position represented in FIG. 14, it achieves a maximum.

FIG. 15 shows a perspective view of the stator disk 1, having two surfaces 34 and 35 and a winding former 35, to which the winding is applied. The winding former 35 is a main body of the stator disk 1, in which recesses 11 are incorporated for the accommodation of the winding 7.

FIG. 16 shows a sectional view of the stator disk 1, wherein a flat wire, by way of a winding 7, is accommodated in recesses 11. Through a cut-out 12, the flat wire is fed from one surface 33 to the other surface 34. A longer side of the flat wire, in cross-section, is arranged parallel to a longitudinal axis or an axis of rotation of the electrical machine.

FIG. 17 shows a perspective view of the winding 7, in a schematic representation with no corresponding disk which, in the present case, is constituted of three wire bundles 7a, 7b and 7c, which are mutually interlocked. The winding 7 is configured in a circular shape, and can be fitted to a disk of the stator 1. The three wire bundles 7a, 7b and 7c, in turn, can be constituted as bundles of flat wire or a plurality of flat wires, and are consistently routed, in an alternating manner, in their tangential portions, from a side which is averted from the viewer through corresponding cut-outs 12 in the stator disk 1 to a side facing the viewer, and vice versa. Accordingly, each of the wire bundles 7a, 7b and 7c can be sectionally arranged on different sides of the stator disk 1. By the employment of three wire bundles 7a, 7b and 7c, three-phase actuation can be achieved.

In the exemplary embodiment represented in FIG. 17, the radial portions of the respective wire are alternately arranged on one side, for example a reverse side which is averted from the viewer by way of a surface 35 of the stator disk, and on another side, for example a front side which faces the viewer and is arranged in opposition to the reverse side, by way of a surface 34 of the stator disk wherein, in each case, each of said portions is exclusively arranged on one side, and the radial portions execute no changeover of sides. Only the tangential portions, of which there is at least one midpoint-proximate portion 9b and at least one midpoint-distant portion 9a, are consistently routed from the front side to the reverse side, and vice versa. In the exemplary embodiment represented, the midpoint-distant portion 9a is consistently routed from the front side to the reverse side, whereas the midpoint-proximate portion 9b is routed from the reverse side to the front side.

FIG. 18 represents an overhead view of the winding 7. Each of the wire bundles 7a, 7b and 7c is arranged such that a midpoint-distant portion 9a, in its course from the front side to the reverse side, coincides with exactly one radial portion of the second wire which is routed on the reverse side and one portion of the third wire which is routed on the front side. The midpoint-proximate portion 9b, in its course from the reverse side to the front side, also overlaps exactly one radial portion 8 of the second wire which is routed on the reverse side, and a radial portion 8 of the third wire which is routed on the front side. In their course, the three wire bundles 7a, 7b and 7c are thus interlocked and, by the action of the Lorentz force associated by the energization thereof with an electric current, a plurality of interaction centers or poles are constituted in a loop, which can be particularly clearly seen in FIG. 18, and is comprised of the individual wire bundles 7a, 7b and 7c.

Each of the cut-outs 12, through which the wire 7b, at a midpoint-proximate portion 9b, is fed from the reverse side 35 to the front side 34, is arranged between a radial portion of the wire bundle 7a, which is routed on the front side, and a radial portion of the wire bundle 7c, which is routed on the reverse side. Correspondingly, at a midpoint-distant portion 9a, the wire bundle 7b is routed from the front side to the reverse side, wherein the front side-routed radial portion 8 of the wire bundle 7c and the reverse side-routed radial portion 8 of the wire bundle 7a are adjacent to the cut-out 12 of the wire bundle 7b. The respective cut-out 12 is thus arranged centrally between the two wires.

FIG. 19 shows a lateral view of the course of the wire bundles 7a, 7b and 7c represented in FIGS. 17 and 18. This provides a clearer illustration of the course of the midpoint-distant portion 9a from the front side which, in this representation, is downward facing, to the reverse side.

Characteristics of the various forms of embodiment which are disclosed solely in the exemplary embodiments can be mutually combined and claimed individually.

1. An electrical machine, having
at least one disk-shaped stator (1) having at least one winding (7) of an electrically-conductive wire, and
at least one rotor (2) which is rotatable relative to the stator (1), having a first permanent magnet (31) and at least one second permanent magnet (32), which are arranged such that
a north pole (N) of the first permanent magnet (31) and a south pole (5) of the second permanent magnet (32) pointing towards the stator (1),
characterized in that
the winding (7) is arranged on the disk-shaped stator (1) radially around the circumference in a serpentine configuration having alternating radially arranged portions (8) and tangentially arranged portions (9), such that
lobes (10) of the winding (7) arranged on two opposing surfaces (33, 34) of the disk-shaped stator (1) only at least partly overlap one another in their radially arranged portions (8), or only partly overlap one another in their tangentially arranged portions (9), wherein
the winding (7) is arranged alternately on one of the two surfaces (33, 34) of the disk-shaped stator (1), or
one winding (7) of the wire is arranged on each of the two surfaces (33, 34) of the disk-shaped stator (1).

2. The electrical machine as claimed in claim 1, characterized in that the at least one winding (7) is arranged such that at least one of the lobes (10) is constituted on one surface (33, 34) of the stator (1) as a multiple turn of the electrically-conductive wire.

3. The electrical machine as claimed in claim 1, characterized in that the constituent wire of the winding (7) arranged on different surfaces (33, 34) of the disk-shaped stator (1) is arranged with a spatial clearance from the wire on the respective other surface (33, 34).

4. The electrical machine as claimed in claim 1, characterized in that the rotor (2) comprises at least two disks, which are arranged coaxially to one another, and between which one disk of the stator (1) is arranged respectively.

5. The electrical machine as claimed in claim 4, characterized in that, for the constitution of an electric motor, the rotor (2) comprises at least three disks, which are arranged coaxially to one another, and between which one disk of the stator (1) is arranged respectively.

6. The electrical machine as claimed in claim 5, characterized in that, for the constitution of an electric generator, the rotor (2) comprises at least four disks, which are arranged coaxially to one another, and between which one disk of the stator (1) is arranged respectively.

7. The electrical machine as claimed in claim 6, characterized in that an electric current source (13) is provided for the supply of electric current to the windings of the stator (1), wherein a phase angle of an electric current in one of the windings (7) of the three disks of the stator (1) respectively shows a difference of 120° in relation to a phase angle of an electric current which flows in one of the other windings of the three disks of the stator (1).

8. The electrical machine as claimed in claim 1, characterized in that an electric current source (13) is provided for the supply of electric current to the windings of the stator (1), wherein the winding (7) on one surface of the stator (1) has a phase angle which is offset by 90° in relation to a phase angle of the winding (7) on the other surface of the stator (1).

9. The electrical machine as claimed in claim 1, characterized in that the winding (7) is constituted of at least two individual and mutually parallel oriented wires.

10. The electrical machine as claimed in claim 1, characterized in that the winding (7) is constituted of a fiat wire, wherein the flat wire is arranged such that one of the broader faces of said flat wire is oriented parallel to an axis of rotation.

11. The electrical machine as claimed in claim 1, characterized in that the winding (7) is secured in a recess (11) in the stator (1).

12. The electrical machine as claimed in claim 11, characterized in that the winding is alternately arranged on one of the two surfaces (33, 34) of the stator (1), wherein the two surfaces (33, 34) each comprise a winding former (35), onto which the winding (7) is wound, wherein the winding (7) is fed from one surface (34) radially at least once through a cut-out (12) in the recess (11), and wound onto the winding former (35) of the opposing surface (33).

13. The electrical machine as claimed in claim 1, characterized in that at least two interlocking windings (7) are arranged on the disk-shaped stator (1), wherein each of the windings (7) is fed from one surface (34) tangentially at least once through a cut-out (12) onto the opposing surface,

14. The electrical machine as claimed in claim 13, characterized in that three interlocking windings (7, 7a, 7b, 7c) are arranged on the disk-shaped stator (1), wherein each of the windings (7, 7a, 7b, 7c) incorporates by way of tangential portions (9) at least one midpoint-proximate portion (9b) and at least one midpoint-distant portion (9a), at which the respective winding (7, 7a, 7b, 7c) is fed from the surface (34) of the stator (1) through the cut-out (12) to the opposing surface (35).

15. The electrical machine as claimed in claim 13, characterized in that each of the cut-outs (12) through which one of the windings (7, 7a, 7b, 7c) is fed is arranged between a radial portion of a winding (7, 7a, 7b, 7c) adjoining said winding (7, 7a, 7b, 7c) which is routed on one surface (34), and a radial portion of a further winding (7, 7a, 7b, 7c) which adjoins said winding (7, 7a, 7b, 7c) and is routed on the opposing surface (35).
